(19) United States
(12) Patent Application Publication
(10) Pub. No.: US 2019/0243790 A1
(43) Pub. Date: Aug. 8, 2019

(54) DIRECT MEMORY ACCESS ENGINE AND METHOD THEREOF

(71) Applicant: Shanghai Zhaoxin Semiconductor Co., Ltd., Shanghai (CN)

(72) Inventors: Xiaoyang Li, Beijing (CN); Chen Chen, Beijing (CN); Zhenhua Huang, Beijing (CN); Weilin Wang, Beijing (CN); Jiin Lai, New Taipei City (TW)

(73) Assignee: Shanghai Zhaoxin Semiconductor Co., Ltd., Shanghai (CN)

(21) Appl. No.: 15/979,466

(22) Filed: May 15, 2018

(30) Foreign Application Priority Data
Feb. 2, 2018 (CN) 201810105485.9

(51) Int. Cl. G06F 13/28; G06F 13/16; G06N 3/02; G06F 9/38

(52) U.S. Cl. CPC G06F 13/28; G06F 9/3887; G06N 3/02; G06F 13/1668

(57) ABSTRACT

A direct memory access (DMA) engine and a method thereof are provided. The DMA engine controls data transmission from a source memory to a destination memory, and includes a task configuration storing module, a control module and a computing module. The task configuration storing module stores task configurations. The control module reads source data from the source memory according to the task configuration. The computing module performs a function computation on the source data from the source memory in response to the task configuration of the control module. Then, the control module outputs destination data output through the function computation to the destination memory according to the task configuration. Accordingly, on-the-fly computation is achieved during data transfer between memories.

### CROSS-REFERENCE TO RELATED APPLICATION

This application claims the priority benefit of China application serial no. 201810105485.9, filed on Feb. 2, 2018. The entirety of the above-mentioned patent application is hereby incorporated by reference herein and made a part of this specification.

### BACKGROUND OF THE INVENTION

### 1. Field of the Invention

The invention relates to a direct memory access (DMA) engine, and particularly relates to a DMA engine adapted for neural network (NN) computation and a method thereof.

### 2. Description of Related Art

With the direct memory access (DMA) technology, data recorded in an address space may be transmitted to a specific address space of a different memory, storage device, or input/output device without using a processor to access the memory. Therefore, DMA enables data transmission at a high speed. The transmission process may be carried out by a DMA engine (also referred to as a direct memory controller), and is commonly applied in hardware devices such as a graphic display, a network interface, a hard drive controller, and/or the like.

On the other hand, the neural network or the artificial neural network is a mathematical model mimicking the structure and function of a biological neural network. The neural network may perform an evaluation or approximation computation on a function, and is commonly applied in the technical field of artificial intelligence. In general, it requires fetching a large amount of data with non-continuous addresses to execute a neural network computation. A conventional DMA engine needs to repetitively start and perform multiple transmission processes to transmit data. The neural network computation is known for a large number of times of data transmission, despite that the amount of data in each time of data transmission is limited. In each time of data transmission, the DMA engine needs to be started and configured, and it may be time-consuming to configure the DMA engine. Sometimes configuring the DMA engine may be more time-consuming than transmitting data. Thus, the conventional neural network computation still needs improving.

### SUMMARY OF THE INVENTION

Based on the above, one or some exemplary embodiments of the invention provides a direct memory access (DMA) engine and a method thereof. According to the DMA engine and method, a neural network-related computation is incorporated into a data transmission process. Therefore, the DMA engine is able to perform on-the-fly computation during the transmission process.

An embodiment of the invention provides a DMA engine configured to control data transmission from a source memory to a destination memory. The DMA engine includes a task configuration storage module, a control module, and a computation module. The task configuration storing module stores task configurations. The control module reads source data from the source memory according to one of the task configurations. The computing module performs a function computation on the source data from the source memory in response to the one of the task configurations of the control module. The control module outputs destination data output through the function computation to the destination memory based on the one of the task configuration.

Another embodiment of the invention provides a DMA method adapted for a DMA engine to control data transmission from a source memory to a destination memory. The DMA method includes the following steps. A task configuration is obtained. Source data is read from the source memory based on one of the task configuration. A function computation is performed on the source data from the source memory in response to the one of the task configuration. Destination data output through the function computation is output to the destination memory based on the one of the task configuration.

Based on the above, compared with the known art where the DMA engine is only able to transmit data, and the computation on the source data is performed by a processing element (PE), the DMA engine according to the embodiments of the invention is able to perform the function computation on the data being transmitted during the data transmission process between the source memory and the destination memory. Accordingly, the computing time of the processing element or the data transmitting time of the DMA engine may be reduced, so as to increase the computing speed and thereby facilitate the accessing and exchanging processes on a large amount of data in neural network-related computation.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a computer system according to an embodiment of the invention.

FIG. 2 is a block diagram illustrating components of a direct memory access (DMA) engine according to an embodiment of the invention.

FIG. 3 is a flowchart illustrating a DMA method according to an embodiment of the invention.

FIG. 4A is an exemplary diagram illustrating a logical operation architecture of an example where a function computation is an average computation.

FIG. 4B is an exemplary diagram illustrating a logical operation architecture of another example where a function computation is an average computation.

FIG. 5 is a diagram providing an example illustrating a three-dimensional data matrix.

FIGS. 6A and 6B are an example illustrating an adjustment to the dimensionality of a data matrix.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

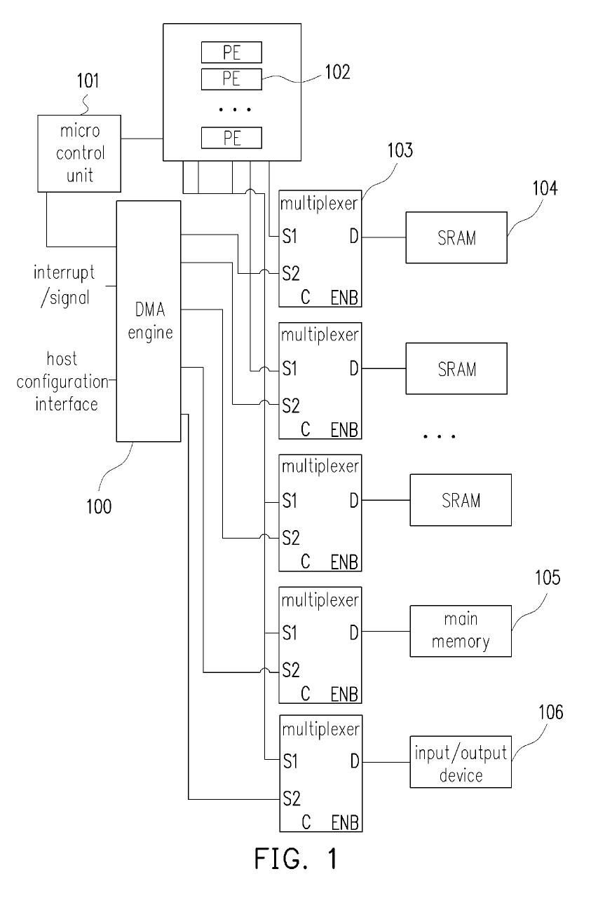

FIG. 1 is a schematic view illustrating a computer system 1 according to an embodiment of the invention. Referring to FIG. 1, the computer system 1 may be, but is not limited to, a desktop computer, a notebook computer, a server, a workstation, a smart phone, and a tablet computer, and may include, but is not limited to, a direct memory access (DMA) engine 100, a micro control unit (MCU) 101, one or more processing elements (PE) 102, one or more static random access memories (SRAM) 104, a main memory 105, and an input/output device 106. In some embodiments, the computer system 1 may include one or more multiplexers 103.

The DMA engine 100 controls data transmission from a source memory (i.e., one of the SRAM 104, the main memory 105, and the input/output device 106) to a destination memory (i.e., another of the SRAM 104, the main memory 105, and the input/output device 106). For example, the MCU 101 assigns tasks of neural network-related computations between the respective processing elements 102 and the DMA engine 100. For example, one of the processing elements 102 (also referred to as a first processing element in the subsequent text) may perform a first convolution computation and then transmit an interruption signal to the MCU 101. After receiving the interruption signal, the MCU 101 may learn from descriptions in a task configuration stored in advance that two subsequent tasks are to be completed by the DMA 100 and another processing element 102 (also referred to as a second processing element) respectively. Accordingly, the MCU 101 may configure to complete a function computation described in the task configuration during a process of transmitting data from one of the memory (i.e., one of the SRAM 104, the main memory 105, and the input/output device 106) of the first processing elements 102 to the memory (i.e., another of the SRAM 104, the main memory 105, and the input/output device 106) of the second processing element 102. The function computation includes, but is not limited to, a maximum computation, an average computation, a scaling computation, a batch normalization (BN) computation, and an activation function computation relating to neural network. The function computation may be achieved by the DMA engine 100 according to the embodiments of the invention as long as the data are not used repetitively and do not require buffering during the computation process. After completing the data transmission and the function computation, the DMA engine 100 may transmit the interruption signal to the MCU 101. After receiving the interruption signal, the MCU 101 learns based on the descriptions in the task configuration stored in advance that the next task is to be completed by the second processing element 102 corresponding to the destination memory of the DMA transmission. Accordingly, the MCU 101 configures the second processing element 102 to perfo n a second convolution computation. It should be noted that the assignment of tasks of neural network-related computations described above is only an example, and the invention is not limited thereto.

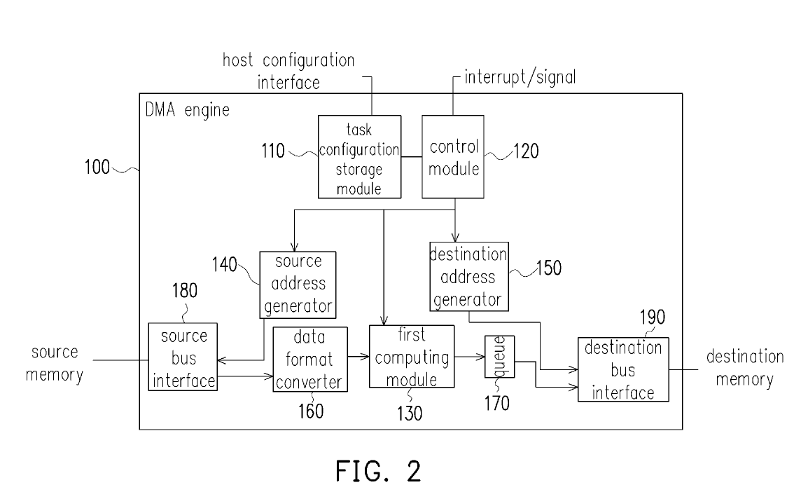

Referring to FIG. 2, the DMA engine 100 (also referred to as a DMA controller) may be an independent chip, processor, or integrated circuit, or be embedded in another chip or hardware circuit. The DMA engine 100 includes, but is not limited to, a task configuration storage module 110, a control module 120, and a first computing module 130. In some embodiments, the DMA engine 100 further includes a source address generator 140, a destination address generator 150, a data format converter 160, a queue 170, a source bus interface 180, and a destination bus interface 190.

The task configuration storage module 110 is coupled to the MCU 101 via a host configuration interface, and may be a storage medium such as a SRAM, a dynamic random access memory (DRAM), a flash memory, or the like, and is configured to record the task configuration from the MCU 101. The task configuration records description information relating to configuration parameters such as a source memory, a source starting address, a destination memory, a destination starting address, a function computation type, a source data length, a priority, an interruption flag, and/or the like. Details in this regard will be described in the subsequent embodiments.

The control module 120 is coupled to the MCU 101. The control module 120 may be a command, control or status register, or a control logic. The control module 120 is configured to control other devices or modules based on the task configuration, and may transmit the interruption signal to the MCU 101 to indicate that the task is completed.

The computing module 130 is coupled to the control module 120. The computing module 130 may be a logic computing unit and compliant with a single instruction multiple data (SIMD) architecture. In other embodiments, the computing module 130 may also be a computing unit of other types. The computing module 130 performs a function computation on input data in response to the task configuration of the control module 120. Based on computational needs, the computing module 130 may include one or a combination of an adder, a register, a counter, and a shifter. Details in this regard will be described in the subsequent embodiments. During the process of transmitting source data from a source memory (i.e., one of the SRAM 104, the main memory 105, and the input/output device 106 of FIG. 1) to a destination memory (i.e., another of the SRAM 104, the main memory 105, and the input/output device 106) by the DMA engine 100 according to the embodiments of the invention, the computing module 130 performs the function computation on the source data. The function computation includes, but is not limited to, a maximum computation, an average computation, a scaling computation, a batch normalization (BN) computation, an activation function operation, and the like relating to neural network. In the function computations, the source data neither needs to be used repetitively nor be buffered. In other words, the source data is stream data and undergoes the computation by the computing module 130 for only one time (i.e., the source data are only subjected to one function computation once).

The source address generator 140 is coupled to the control module 120. The source address generator 140 may be an address register, and is configured to generate a specific source address in the source memory (i.e., the SRAM 104, the main memory 105, or the input/output device 106 shown in FIG. 1) based on a control signal from the control module 120 to read the source data from the source memory via the source bus interface 180.

The destination address generator 150 is coupled to the control module 120. The destination address generator 150 may be an address register, and is configured to generate a specific destination address in the destination memory (i.e., the SRAM 104, the main memory 105, or the input/output device 106 shown in FIG. 1) based on a control signal from the control module 120 to output/write the destination data output from the computing module 130 to the destination memory via the destination bus interface 190.

The data format converter 160 is coupled to the source bus interface 180 and the computing module 130. The data format converter 160 is configured to convert the source data from the source memory into multiple parallel input data. The queue 170 is coupled to the computing module 130 and the destination bus interface 190, and may be a buffer and a register, and is configured to temporarily store the destination data to be output to synchronize phase differences between clocks of the source and destination memories.

The MCU 101 is coupled to the DMA engine 100. The MCU 101 may be any kind of programmable units, such as a central processing unit, a micro-processing unit, an application specific integrated circuit, or a field programmable gate array (FPGA), compatible with reduced instruction set computing (RISC), complex instruction set computing (CISC), or the like and configured for the task configuration.

The one or more processing elements 102 form a processing array and are connected to the MCU 101 to perform computation and data processing. The respective multiplexers 103 couple the DMA engine 100 and the processing element 102 to the SRAM 104, the main memory 105 (e.g., DRAM), and the input/output device 106 (e.g., a device such as a graphic display card, a network interface card, or a display), and are configured to control an access operation of the DMA engine 100 or the processing element 102 to the SRAM 104, the main memory 105, and the input/output device 106. In the embodiment of FIG. 1, it is assumed that each of the SRAM 104, the main memory 105, and the input/output device 106 has only one read/write port. Therefore, the multiplexers 103 are required to choose the DMA engine 100 or the processing element 102 to access the SRAM 104, the main memory 105, and the input/output device 106. However, the invention is not limited thereto. In another embodiment where each of the SRAM 104, the main memory 105, and the input/output device 106 has two read/write ports, the multiplexers 103 are not required.

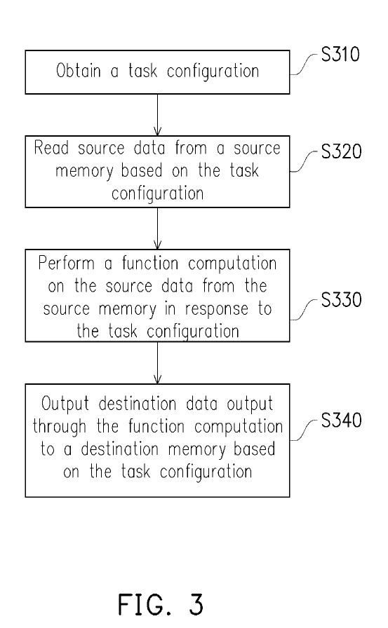

For the ease of understanding the operational procedures of the embodiments of the invention, several embodiments are described in the following to explain an operational flow of the DMA engine 100 according to the embodiments of the invention in detail. FIG. 3 is a flowchart illustrating a DMA method according to an embodiment of the invention. Referring to FIG. 3, the method of the embodiment is suitable for the DMA engine 100 of FIG. 2. In the following, the method according to the embodiment of the invention is described with reference to the respective elements and modules in the computer system 1 and the DMA engine 100. The respective processes of the method are adjustable based on details of implementation and is not limited thereto.

The task configuration from the MCU 101 is recorded at the task configuration storage module 110 via the host configuration interface. Accordingly, the control module 120 may obtain the task configuration (Step S310). In the embodiment, the task configuration includes, but is not limited to, the source memory (which may be the SRAM 104, the main memory 105, or the input/output device 106) and the source starting address thereof; the destination memory (which may be the SRAM 104, the main memory 105, or the input/output device 106) and the destination starting address thereof; the DMA mode, the function computation type, the source data length, and other dependence signals (when the dependence signal is satisfied, the DMA engine 100 is driven to perform the task assigned by the MCU 101). In addition, the DMA mode includes, but is not limited to, dimensionality (e.g., one dimension, two dimensions or three dimensions), stride, and size.

Regarding the different dimensions in the DMA mode, Table (1) lists parameters recorded respectively.

TABLE (1)

| Dimension | Stride | Size | Stride | Size | Stride | Size |
|---|---|---|---|---|---|---|
| 1D | stride1 | size1 | | | | |
| 2D | stride1 | size1 | stride2 | size2 | | |
| 3D | stride1 | size1 | stride2 | size2 | stride3 | size3 |

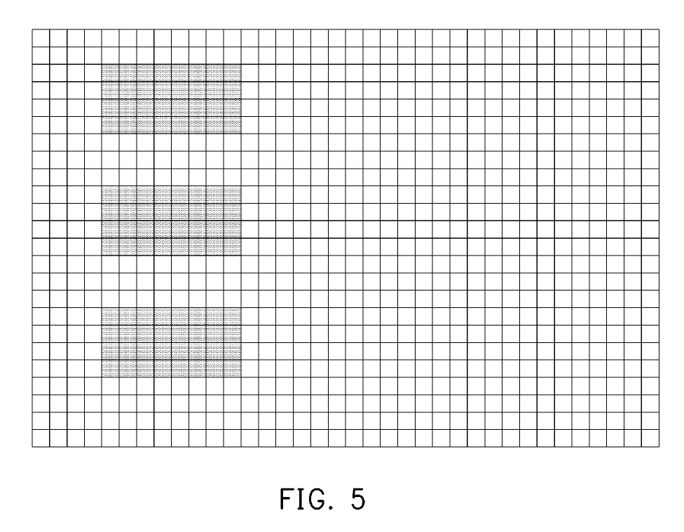

For a one-dimensional data matrix, the stride stride1 represents the distance of a hop reading interval, i.e., a difference between starting addresses of two adjacent elements. The size size1 represents the number of elements included in the source data. For a two-dimensional data matrix, the stride stride1 represents the distance of a row hop reading interval, the size size1 represents the number of row elements included in the source data, the stride stride2 represents the distance of a column hop reading interval, and the size size2 represents the number of column elements included in the source data. For a three-dimensional data matrix, with reference to the example of FIG. 5, the parameters are as shown in Table (2) below:

TABLE (2)

| Dimension | Stride | Size | Stride | Size | Stride | Size |
|---|---|---|---|---|---|---|
| 3D | stride1 = 1 | size1 = 8 | stride2 = 36 | size2 = 4 | stride3 = 144 | size3 = 3 |

The stride stride1 of 1 and the size size1 of 8 indicate that the data size of the one-dimensional matrix is in the size of 8 elements (as shown in FIG. 5, a marked meshed area in the third row forms 8 elements), and a hop stride between two adjacent elements is 1. In other words, the addresses of adjacent elements are continuous. The stride stride2 of 36 and the size size2 of 4 indicate that the data size of the two-dimensional matrix is in the size of 4 elements (as shown in FIG. 5, a marked meshed area in the third to sixth rows forms 4 elements, each row forming one element), and the hop stride between two adjacent elements is 36. In other words, the difference between the starting addresses of the adjacent elements is 36. The stride stride3 of 144 and the size size3 of 3 indicate that the data size of the three-dimensional matrix is in the size of 3 elements (as shown in FIG. 5, marked meshed areas in the third to sixth rows, the tenth to thirteenth rows, and the seventeenth to twentieth rows form 3 elements, each 4×8 matrix forming an element), and the hop stride between two adjacent elements is 144. In other words, the difference between the starting addresses of the adjacent elements is 144.

Regarding the task configuration, if the DMA engine 100 adopts scatter-gather transmission, a linked list shown in Table (3) may serve as an example. In the scatter-gather transmission, a physically discontinuous storage space is described with a linked list, and the starting address is notified. In addition, after a block of physically continuous data is transmitted, physically continuous data of the next block is transmitted based on the linked list without transmitting the interruption signal. Another new linked list may be initiated after all the data described in the linked list. Details of Table (3) are shown in the following:

TABLE 3

| Task ID (ID) | Configuration parameter | Next task |
|---|---|---|
| 0 | Source memory (src): SRAM0, | 2 |
| | Source stalling address (src starting addr): | |
| | 0 × 1000, | |
| | Destination memory (dest): SRAM1, | |
| | Destination starting address (src starting addr): | |
| | 0 × 2000, | |
| | Direct memory access mode (DMA mode): 2D | |
| | (stride1 = 1, size1 = 64, stride2 = 36, size2 = | |
| | 64), | |
| | SMID: 4 (the number of parallel inputs of the | |
| | computing module 130), average computation | |
| | (average) (which indicates that the function | |
| | computation is to perform an average | |
| | computation on four parallel input data) | |
| 1 | | |
| 2 | | 7 |
| . . . | | |
| 7 | | NULL |

After the task 0 is completed, the control module 120 then executes the task 2 based on the linked list.

It should be noted that the DMA engine 100 may also adopt block transmission, where one interruption is induced when one block of physically continuous data is transmitted, and the next block of physically continuous data is transmitted after reconfiguration of the MCU 101. In such case, the task configuration may record only the configuration parameter of one task.

Then, based on the source memory, the source starting address thereof, and the direct memory access mode, the control module 120 may instruct the source address generator 140 to generate the source address in the source memory, and read the source data from the designated source memory via the source bus interface 180 (Step S320). For example, Table 3 indicates that the source memory is SRAM0, and the source starting address thereof is 0x1000. Thus, the source address generator 140 may generate a source address starting from the source address 0x1000 in the source memory SRAM0, i.e., “stride stride1=1, size size1=64, stride stride2=36, and size size2=64′”, which indicates that the source data is a two-dimensional matrix, the first dimension (row) includes 64 elements, and the hop stride between two adjacent elements is one data storage address (i.e., the addresses of elements in two adjacent columns are continuous), the second dimension (column) also includes 64 elements, and the hop stride between two adjacent column elements is 36 (i.e., the starting addresses of two adjacent column elements are spaced apart by 36 data storage addresses).

In the conventional DMA engine, after reading the source data from the source memory, the source data may be directly written into a specific address of the destination memory. What differs from the known art is that the computing module 130 according to the embodiments of the invention further performs a function computation on the source data from the source memory in response to instructions of the control module 120 based on the type of the function computation and the data length of the source data in the task configuration (Step S330). The function computation includes, but is not limited to, the maximum computation (i.e., obtaining the maximum among several values), the average computation (i.e., adding up several values and dividing the summation by the number of values), the scaling computation, the batch normalization (BN) computation, the activation function computation (such that the output of each layer of the neural network is a non-linear function of the input, instead of a linear combination of the input, and such computation may approximate any function such as sigmoid, tan h, ReLU functions, and the like), and/or the like that are related to neural network. In general, the source data neither needs buffering nor needs to be used repetitively. Any function computation that undergoes the computation by the computing module 130 for only one time may be implemented during a process where the computing module 130 according to the embodiments of the invention performs DMA data transmission in the DMA engine 100.

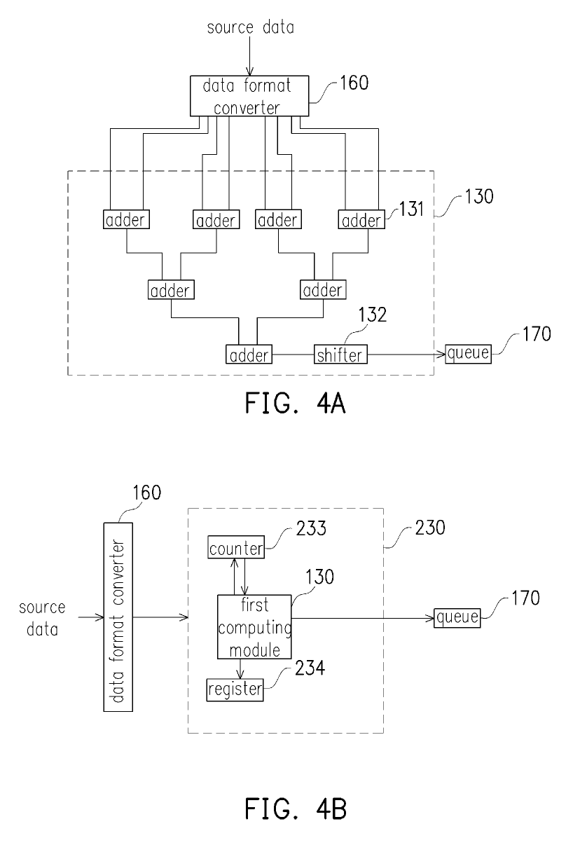

For example, FIG. 4A is a diagram illustrating a logical operation architecture of an example where a function computation is an average computation. Referring to FIG. 4A, it is assumed that the function computation is an average computation, the data length of the source data input to the computing module 130 is 8 (i.e., the source data includes eight elements), and the first computing module 130 is compatible with the architecture of SIMD. The first computing module 130 includes multiple adders 131 and a shifter 132 that shifts three positions. The source data is input to the data format converter 160. It should be noted that effective data in the source data input to the data format converter 160 via the source bus interface 180 may have discontinuous addresses. The data format converter 160 may fetch the effective data from the source data, and converts the effective data into multiple parallel input data. It is noted that a bit width of the effective data is equivalent to a bit width of the computing module 130. For example, if the target of the SIMD computation executed by the first computing module 130 has eight elements, and the bit width of each of the elements is 16 bits, for example (i.e., the bit width of the first computing module 130 is 128 bits), when the bit width of the effective data fetched by the data format converter 160 accumulates to 128 bits, the 128 bits are converted into eight 16-bit parallel input data and input to the first computing module 130. In an embodiment, the bit width of the first computing module 130 is designed to be at least equal to the bit width of the source bus interface 180, such as 128 bits. If the effective data have discontinuous addresses, the data format converter 160 may fetch at least one 16-bit effective data from the 128-bit source data read at one time based on the stride and size parameters included in the task configuration. When the total length of the effective data accumulates to 128 bits, the data format converter 160 converts the 128-bit effective data into eight 16-bit parallel input data, and input the eight 16-bit parallel input data to the first computing module 130. Accordingly, the first computing module 130 may execute a parallel computation on the parallel input data based on the SIMD technology to achieve multi-input computation. If the effective data have continuous addresses, the 128-bit source data read at one time from the source bus interface 180 may be directly converted by the data format converter 160 into eight 16-bit parallel input data and input to the first computing module 130. The bit width of the first computing module 130 is designed to be 128 bits to avoid a hardware bottleneck where the first computing module 130 is unable to receive and perform computation on the source data at one time when the source data read at one time from the source bus interface 180 are all effective data.

FIG. 4B is a diagram illustrating a logical operation architecture of an example where a function computation is an average computation. FIG. 4B is adapted for a case where the bit width of the function computation exceeds a bit width of the hardware of a second computing module 230. Referring to FIG. 4B, it is assumed that the function computation is also the average computation, the data length input to the second computing module 230 is 8 (i.e., the source data has eight elements), and the size of each element is 16 bits. In addition, the second computing module 230 is also compatible with the SIMD architecture, and the bit width thereof is 128 bits. What differs from the embodiment of FIG. 4A is that, the function computation of the embodiment requires to perform the average computation on 32 16-bit elements, while the bit width of the function computation is 512 bits, which exceeds the hardware bit width of the second computing module 230. Thus the second computing module 230 includes the first computing module 130, a counter 233, and a register 234. Based on the SIMD technology, the first computing module 130 performs a parallel computation on the 128-bit effective data input in parallel by the data format converter 160. Details of the first computing module 130 of FIG. 4B are the same as the first computing module 130 of FIG. 4A, and thus will not be repeated in the following. The counter 233 is connected to the first computing module 130 and counts the number of times of the parallel computation. The register 234 records intermediate results of the function computation, such as the result of each parallel computation. The function computation of the embodiment requires the first computing module 130 to perform the parallel computation for four times, and then perform the parallel computation on the result of each parallel computation recorded in the register 234, so as to compute the average of the 32 elements. However, the invention is not limited thereto. For example, the first computing module 130 may only perform an cumulative computation on 32 elements, and then outputs a total of the accumulation to an external shifter (not shown) to obtain the average.

It should be noted that, based on different function computations, the first computing module 130 and the second computing module 230 may have different logical computation architectures to cope with the needs. The embodiments of the invention do not intend to impose a limitation on this regard. For example, the first computing module 130 may also be a multiply and accumulate tree.

Then, the control module 120 instructs the destination address generator 150 to generate the destination address in the destination memory based on the destination memory, the destination starting address thereof, and the direct memory access mode recorded in the task configuration, so that the destination data output through the function computation is output to the destination memory via the destination bus interface 190 (Step S340). For example, Table (3) indicates that the destination memory is SRAM1, and the destination starting address is 0x2000. It should be noted that the data lengths before and after the average computation and the maximum computation may be different (i.e., multiple inputs and single output). In other words, after performing the function computation on the source data, the computing module 130 may output the destination data in a size different from that of the source data (i.e., the transmission length of the destination data is different from the transmission length of the source data). Therefore, the configuration parameter in the task configuration according to the embodiments of the invention only records the starting address of the destination address without limiting the data length of the destination data. The data length of the source data may be obtained based on the stride and the size.

Since the size of the destination data is unknown, in order to deal with the ending of the DMA transmission, the source address generator 140 in an embodiment may firstly set an end tag of an end address of the source data based on the data length of the source data obtained according to the task configuration (i.e., stride and size). The destination address generator 150 may determine that the transmission of the source data is completed when the end address with the end tag is processed, and may notify the control module 120 to detect the next task configuration in the task configuration storage module 110. In another embodiment, when the MCU 101 or the control module 120 configures the task configuration, the MCU 101 or the control module 120 may obtain the data length of the destination data based on the data length of the source data and the type of function computation, and write the data length of the destination data to the destination address generator 150. Accordingly, the destination address generator 150 may obtain the data length of the destination data corresponding to the task configuration.

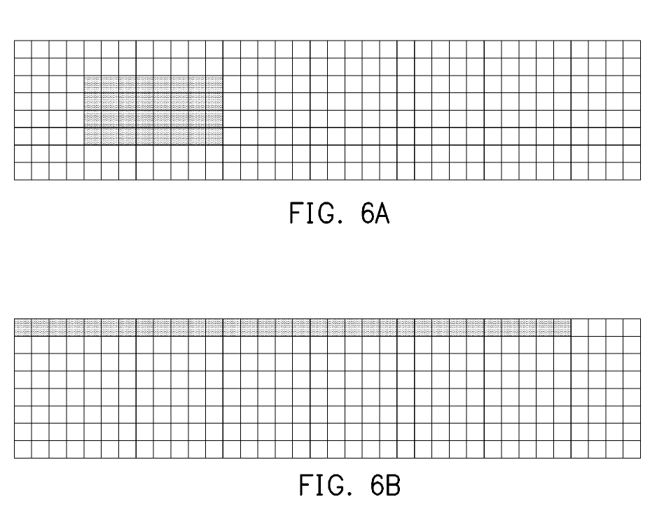

In addition, the DMA engine 100 according to the embodiments of the invention may further adjust the format of the data output to the destination memory based on the format of the input data required by the second processing element 102 for a subsequent (or next) computation. Accordingly, the source address and the destination address have different dimensionalities. Taking the data format of the memory address shown in FIGS. 6A and 6B, FIG. 6A is a two-dimensional address (i.e., a 4×8 two-dimensional matrix) generated by the source address generator 140. Assuming that the input data format of the second processing element 102 for the subsequent computation is a one-dimensional address, the destination address generator 150 may generate an one-dimensional address (i.e., an 1×32 one-dimensional matrix) accordingly, as shown in FIG. 6B. Accordingly, during the process moving the data by the DMA engine 100, the data format may also be adjusted. Therefore, the second processing element 102 may obtain the required data within a time period without having to adjust the data format.

It should be noted that, the destination address generator 150 of the DMA engine 100 may further convert a three-dimensional address generated by the source address generator 140 into an one-dimensional or two-dimensional address, convert a two-dimensional address into a three-dimensional address, convert an one-dimensional address into a two-dimensional or three-dimensional address, or even maintain the dimensionality based on the format of input data of the second processing element 102, depending on the needs.

In view of the foregoing, during the process of moving data between two memories, the DMA engine according to the embodiments of the invention is not only able to perform the function computation relating to neural network but is also able to adjust the data format, so as to share the processing and computational load of the processing element. According to the embodiments of the invention, the computation handled by the processing element in the known art is directly carried out on the source data in an on-the-fly manner by the DMA engine during the DMA transmission between the memories of the processing elements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A direct memory access (DMA) engine, configured to control data transmission from a source memory to a destination memory, wherein the DMA engine comprises:
a task configuration storage module, storing at least one task configuration;
a control module, reading source data from the source memory based on one of the task configuration; and
a computing module, performing a function computation on the source data from the source memory in response to the one of the task configuration of the control module, wherein the control module outputs destination data output through the function computation to the destination memory based on the one of the task configuration.

2. The DMA engine as claimed in claim 1, wherein the source data undergoes the function computation performed by the computing module for only one time.

3. The DMA engine as claimed in claim 1, further comprising:
a data format converter, coupled to the computing module and converting the source data from the source memory into a plurality of parallel input data and inputting the parallel input data to the computing module, wherein
the computing module performs a parallel computation on the parallel input data.

4. The DMA engine as claimed in claim 3, wherein the computing module is compliant with a single instruction multiple data (SIMD) architecture.

5. The DMA engine as claimed in claim 3, wherein the data format converter extracts effective data of the source data, and converts the effective data into the parallel input data, wherein a bit width of the effective data is equal to a bit width of the computing module.

6. The DMA engine as claimed in claim 1, wherein the computing module comprises:
a register, recording an intermediate result of the function computation;
a computing unit, performing a parallel computation on the source data; and
a counter, coupled to the computing unit and counting the number of times of the parallel computation, wherein the function computation comprises a plurality of times of the parallel computation.

7. The DMA engine as claimed in claim 1, wherein the one of the task configuration is adapted to indicate a type of the function computation and a data length of the source data.

8. The DMA engine as claimed in claim 1, further comprising:
a source address generator, coupled to the control module and setting an end tag at an end address in the source data based on a data length of the source data indicated in the one of the task configuration; and
a destination address generator, coupled to the control module, and determining that transmission of the source data is completed when the end address with the end tag is processed.

9. The DMA engine as claimed in claim 1, further comprising:
a destination address generator, coupled to the control module and obtaining a data length of the destination data corresponding to the one of the task configuration, wherein the data length of the destination data is obtained based on a type of the function computation and a data length of the source data indicated in the one of the task configuration.

10. The DMA engine as claimed in claim 1, further comprising:
a source address generator, coupled to the control module, and generating a source address in the source memory based on the one of the task configuration; and
a destination address generator, coupled to the control module, and generating a destination address in the destination memory based on the one of the task configuration, wherein the one of the task configuration further indicates an input data format of a processing element for subsequent computation.

11. A direct memory access (DMA) method, adapted for a DMA engine to control data transmission from a source memory to a destination memory, wherein the DMA method comprises:
obtaining at least one task configuration;
reading source data from the source memory based on one of the task configuration;
performing a function computation on the source data from the source memory in response to the one of the task configuration; and
outputting destination data output through the function computation to the destination memory based on the one of the task configuration.

12. The DMA method as claimed in claim 11, wherein the source data undergoes the function computation for only one time.

13. The DMA method as claimed in claim 11, wherein performing the function computation on the source data from the source memory comprises:
converting the source data from the source memory into a plurality of parallel input data; and
performing a parallel computation on the parallel input data.

14. The DMA method as claimed in claim 13, wherein performing the parallel computation on the parallel input data comprises:
performing the parallel computation based on a single instruction multiple data (SIMD) technology.

15. The DMA method as claimed in claim 13, wherein converting the source data from the source memory into the parallel input data comprises:
extracting effective data in the source data; and
converting the effective data into the parallel input data, wherein a bit width of the effective data is equal to a bit width required in a single computation of the parallel computation.

16. The DMA method as claimed in claim 11, wherein performing the function computation on the source data from the source memory comprises:
recording an intermediate result of the function computation by a register;
counting the number of times of the parallel computation by a counter, wherein the function computation comprises a plurality of times of the function computation.

17. The DMA method as claimed in claim 11, wherein the one of the task configuration is adapted to indicate a type of the function computation and a data length of the source data.

18. The DMA method as claimed in claim 11, wherein performing the function computation on the source data from the source memory comprises:
setting an end tag at an end address in the source data based on a data length of the source data indicated in the one of the task configuration; and
determining that transmission of the source data is completed in response to that the end address with the end tag is processed.

19. The DMA method as claimed in claim 11, wherein performing the function computation on the source data from the source memory comprises:
obtaining a data length of the destination data corresponding to the one of the task configuration, wherein the data length of the destination data is obtained based on a type of the function computation and a data length of the source data indicated in the one of the task configuration.

20. The DMA method as claimed in claim 11, wherein performing the function computation on the source data from the source memory comprises:
generating a source address in the source memory based on the one of the task configuration; and
generating a destination address in the destination memory based on the one of the task configuration, and the one of the task configuration further indicates an input data format of a processing element for subsequent computation.
